(19) United States
(12) Patent Application Publication
(10) Pub. No.: US 2013/0227124 A1
(43) Pub. Date: Aug. 29, 2013

(54) APPARATUS AND METHOD OF PORTABLE TERMINAL FOR TRANSMITTING CONTENTS ACCORDING TO NETWORK ENVIRONMENT

(71) Applicant: Samsung Electronics Co. Ltd., (US)

(72) Inventor: Dae-Eui YOON, Suwon-si (KR)

(73) Assignee: SAMSUNG ELECTRONICS CO. LTD., Suwon-si (KR)

(21) Appl. No.: 13/773,196

(22) Filed: Feb. 21, 2013

(30) Foreign Application Priority Data
Feb. 23, 2012 (KR) 10-2012-0018352

(51) Int. Cl. H04L 29/06

(52) U.S. Cl. CPC H04L 67/42
USPC 709/224

(57) ABSTRACT

A method of operating a portable terminal is provided. The method includes confirming a delay in reception of an Internet Protocol (IP) address of a specific server requested to a Domain Name System (DNS) server, re-requesting the IP address of the specific server to the DNS server by increasing an interval of a DNS query, confirming a delay in a socket connection requested to the specific server, and re-requesting the socket connection to the specific server by increasing an interval of a sync.

### PRIORITY

This application claims the benefit under 35 U.S.C. §119(a) of a Korean patent application filed on Feb. 23, 2012 in the Korean Intellectual Property Office and assigned Serial No. 10-2012-0018352, the entire disclosure of which is hereby incorporated by reference.

### BACKGROUND OF THE INVENTION

1. Field of the Invention

The present invention relates to an apparatus and method of a portable terminal for transmitting contents according to a network environment.

2. Description of the Related Art

As a network environment is developed, large-volume contents can be uploaded and downloaded between a client and a server. For example, the large-volume contents can be transmitted between the client and the server by using a multimedia message service, an e-mail, a social network service, etc.

However, when the contents are uploaded from the client to the server, transmission fails occasionally according to a network environment, etc. Conventionally, in this case, retransmission is attempted by using the same predetermined algorithm without considering the network environment. That is, since the contents are retransmitted from the client to the server by using the same algorithm without considering a current network environment, the conventional method has a low success rate of retransmission.

Therefore, a need exists for an apparatus and method for retransmitting contents according to a network environment to increase the success rate of retransmission.

### SUMMARY OF THE INVENTION

Aspects of the present invention are to address at least the above-mentioned problems and/or disadvantages and to provide at least the advantages described below. Accordingly, an aspect of the present invention is to provide an apparatus and method capable of increasing a success rate of retransmission by configuring various algorithms suitable for a current network environment without having to use a fixed algorithm when contents are retransmitted from a client to a server.

Another aspect of the present invention is to provide an apparatus and method capable of flexibly coping with a variable network environment in such a manner that when contents are retransmitted from a client to a server, a database is generated and stored according to each network environment so that the stored database can be utilized when retransmission is performed at a later time.

In accordance with an aspect of the present invention, a method of operating a portable terminal is provided. The method includes confirming a delay in reception of an Internet Protocol (IP) address of a specific server requested to a Domain Name System (DNS) server, re-requesting the IP address of the specific server to the DNS server by increasing an interval of a DNS query, confirming a delay in a socket connection requested to the specific server, and re-requesting the socket connection to the specific server by increasing an interval of a sync.

In accordance with an aspect of the present invention, a method of operating a portable terminal is provided. The method includes confirming a retransmission count for retransmitting contents to a server, regulating a size of the contents according to the retransmission count and transmitting to the server the contents having the size regulated, and determining whether ACKnowledge (ACK) for the transmission is received from the server.

In accordance with an aspect of the present invention, a method of operating a portable terminal is provided. The method includes uploading specific contents to a server, receiving an error code from the server, and determining a size of the contents by comparing the size of the contents with a size of a Maximum Segment Size (MSS) of the server.

In accordance with an aspect of the present invention, a portable terminal apparatus is provided. The portable apparatus includes a controller for confirming a delay in reception of an Internet Protocol (IP) address of a specific server requested to a Domain Name System (DNS) server and for confirming a delay in a socket connection requested to the specific server, and a communication module for re-requesting the IP address of the specific server to the DNS server by increasing an interval of a DNS query and for re-requesting the socket connection to the specific server by increasing an interval of a sync.

In accordance with an aspect of the present invention, a portable terminal apparatus is provided. The portable apparatus includes a controller for confirming a retransmission count for retransmitting contents to a server and for determining whether an ACKnowledge (ACK) is received from the server, and a communication module for regulating a size of the contents according to the retransmission count and transmitting to the server the contents having the regulated size.

In accordance with an aspect of the present invention, a portable terminal apparatus is provided. The portable apparatus includes a communication module for uploading specific contents to a server and for receiving an error code from the server, and a controller for determining a size of the contents by comparing a size of the contents with a size of Maximum Segment Size (MSS) of the server.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 illustrates an overall structure of a Domain Name System (DNS) server, a portable terminal, and a server according to an exemplary embodiment of the present invention;

FIG. 2 is a flowchart illustrating a solution for a case in which a DNS query delay occurs according to an exemplary embodiment of the present invention;

FIG. 3 is a flowchart illustrating a solution for a case in which a response delay occurs with respect to a socket connection according to an exemplary embodiment of the present invention;

FIG. 4 is a flowchart illustrating a solution for a case in which retransmission of specific contents is requested according to an exemplary embodiment of the present invention;

FIG. 5 is a flowchart illustrating an exemplary solution for a case in which ACKnowledge (ACK) for retransmission is not received from a server according to an exemplary embodiment of the present invention;

FIG. 6 is a flowchart illustrating an exemplary solution for a case in which an error code is received from a server according to an exemplary embodiment of the present invention; and

FIG. 7 is a block diagram illustrating a structure of a portable terminal according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention will be described herein below with reference to the accompanying drawings. In the following description, well-known functions or constructions are not described in detail since they would obscure the invention in unnecessary detail. Also, the terms used herein are defined according to the functions of the present invention. Thus, the terms may vary depending on user's or operator's intension and usage. That is, the terms used herein must be understood based on the descriptions made herein. Further, like reference numerals denote parts performing similar functions and actions through the drawings.

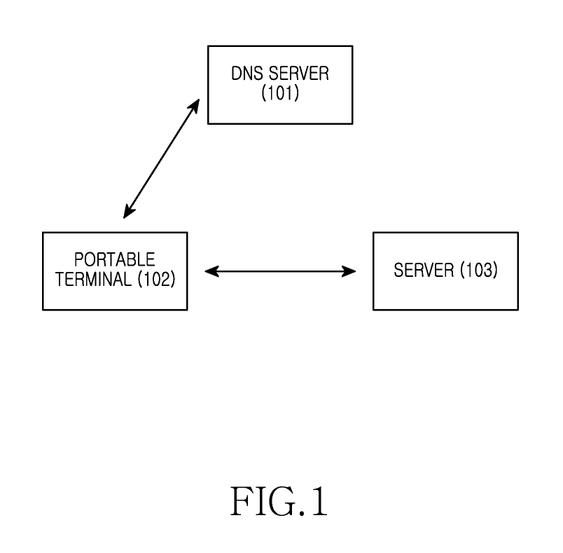

FIG. 1 illustrates an overall structure of a Domain Name System (DNS) server, a portable terminal, and a server according to an exemplary embodiment.

Referring to FIG. 1, an exemplary embodiment includes a DNS server 101, a portable terminal 102, and a server 103.

The DNS server 101 is also called a name server, and serves to report to the portable terminal 102 an Internet Protocol (IP) address of a specific server to which the portable terminal 102 intends to access. More specifically, it is necessary to use the IP address rather than a Uniform Resource Locator (URL) of the server in order for the portable terminal 102 to access the specific server 103, and the DNS server 101 serves to change the URL input from the portable terminal 102 into the IP address of the server. For example, when a user inputs the URL of the specific server to the portable terminal to access the specific server, the DNS server changes the URL of the server into the IP address. As described above, a process of changing the URL into the IP address is called a name resolution.

The DNS server 101 transmits the IP address of the specific server to the portable terminal 102 upon receiving a request of the IP address of the specific server 103 from the portable terminal 102. Herein, a transmission delay may occur when the DNS server 101 transmits the IP address of the specific server 103, requested from the portable terminal 102, to the portable terminal 102. More specifically, a DNS query is occasionally delayed due to a problem of various network environments, etc. One of main reasons of occurrence of the aforementioned DNS query problem in the conventional method is that a response for the DNS query is transmitted from the DNS server 101 to the portable terminal 102 at a time later than an actual time-out. For example, if it is assumed that a time-out of the response for the DNS query is 3 seconds in the portable terminal, since a response time for the DNS query is actually more than 3 seconds in the DNS server, the response for the DNS query is frequently delayed in the portable terminal 102.

In addition thereto, the conventional method cannot solve the problem of the delay in the DNS query because the portable terminal 102 re-requests the IP address of the specific server to the DNS server 101 by using the same algorithm when the response for the DNS query is delayed.

However, according to an aspect of an exemplary embodiment, a solution for the aforementioned delay of the DNS query by considering a practical network environment instead of using the same algorithm as that used in the conventional method is provided. More specifically, the portable terminal 102 re-requests the IP address of the specific server 103 to the DNS server 101 by increasing an interval of the DNS query. That is, the portable terminal 102 re-requests the IP address of the specific server 103 to the DNS server 101 by increasing a time interval of the DNS query by a determined time in proportion to the increase in a count of the DNS query. More specifically, if the portable terminal 102 confirms the delay of the DNS query, when the IP address of the specific server 103 is re-requested to the DNS server 101, the IP address is re-requested to the DNS server 101 at 1 second, 3 seconds, and 6 seconds later respectively in first, second, and third re-request processes. Therefore, there is an advantage in that a count of DNS query delay which has frequently occurred in the conventional method can be decreased.

The portable terminal 102 can receive from the DNS server 101 the IP address of the specific server 103 to which the user desires to access, and can upload specific contents desired by the user to the server 103. According to an exemplary embodiment, a solution for several problems occurring when the portable terminal 102 uploads the specific contents to the server 103 is provided. A first method is for solving a case in which there is no response for a socket connection established to the server 103 when the portable terminal 102 requests the socket connection to the server 103. More specifically, a process of connecting a socket between the portable terminal 102 and the server 103 must be performed in advance in order for the portable terminal 102 to upload the specific contents to the server 103.

That is, when the portable terminal 102 requests the socket connection to the server 103, the server 103 transmits a response for the socket connection to the portable terminal 102. However, a case in which the portable terminal 102 fails to receive the response for the socket connection from the server 103 frequently occurs in the conventional method due to a network problem or the like. For example, if it is assumed that the time-out of the response for the socket connection is 3 seconds in the portable terminal 102, the response for the socket connection is frequently delayed in the portable terminal 102 because a response time for the socket connection is more than 3 seconds in a server 103 actually in use. In this case, in the conventional method, the request of the socket connection is re-attempted at a time less than or equal to a response time of the server 103 without considering the response time of the server 103.

Therefore, the conventional method cannot solve the problem of the response delay for the socket connection. Meanwhile, according to an aspect of an exemplary embodiment, a solution for the aforementioned delay of the response for the socket connection by considering a practical network environment without using the same algorithm used in the conventional method, in which the socket connection is re-requested periodically, is provided. More specifically, the socket connection to the server 103 is re-requested by increasing an interval of a sync for the socket connection from the portable terminal 102 to the server 103. That is, the socket connection from the portable terminal 102 to the server 103 is re-requested by increasing a time interval of the sync by a determined time in proportion to the increase in a count of the sync.

More specifically, if the portable terminal 102 confirms the delay of the sync, when the socket connection is re-requested to the server 103, the socket connection is re-requested to the server 103 at 1 second, 3 seconds, and 6 seconds later respectively in first, second, and third re-request processes. Therefore, there is an advantage in that a count of sync delay which has frequently occurred in the conventional method can be decreased.

A second method is for solving a case in which retransmission is requested to the portable terminal 102 when the portable terminal 102 uploads specific contents to the server 103. More specifically, the method is for handling a situation in which the portable terminal 102 receives a retransmission request from a router located between the portable terminal 102 and the server 103 due to such a reason as a packet size or a current network traffic. When the specific contents are uploaded to the server 103, the portable terminal 102 confirms how frequently retransmission is requested from the router.

First, if the portable terminal 102 determines that a retransmission count is zero as a result of confirming the retransmission count, the portable terminal 102 transmits to the server 103 contents having the same size as contents initially transmitted to the server 103 without regulating the size of the contents. More specifically, if the portable terminal 102 confirms that the retransmission count is zero, it implies that a network environment for uploading specific contents to the server is good. Therefore, it is enough for the portable terminal 102 to continuously upload the contents having the same size as initial contents to the server 103 without having to decrease the size of the contents initially transmitted to the server 103.

If the portable terminal 102 confirms that retransmission count is less than or equal to a predetermined first count, the portable terminal 102 transmits to the server 103 contents having a size obtained by subtracting a determined reference size from an initially-determined size (i.e., default size). Herein, the default size implies a value which is initially determined by the user of the portable terminal 102. Examples of a currently used default value include 1500 bytes, 1460 bytes, and 1410 bytes. In addition, the determined reference size is defined as a specific size predetermined by a vendor. That is, the reference size may vary depending on the vendor. For example, if the vendor is AT&T, 10 bytes are used as the reference size, and if the vendor is Orange, 5 bytes are used as the reference size. If the portable terminal 102 confirms that the retransmission count is greater than a predetermined first count and less than or equal to a predetermined second count, the portable terminal 102 transmits to the server 103 contents having a size obtained by subtracting a double size of the determined reference size from the default size.

If the portable terminal 102 confirms that the retransmission count is greater than the predetermined second count, the portable terminal 102 transmits to the server 103 contents having a size obtained by subtracting a triple size of the determined reference size from the default size. As described above, an exemplary embodiment has an advantage in that communication optimized to a current network environment can be performed by confirming the retransmission count when the portable terminal 102 transmits specific contents to the server 103.

A third method is for solving a case in which no ACKnowledge (ACK) for retransmission is received from the server 103 when the portable terminal 102 retransmits specific contents to the server 103. More specifically, when the portable terminal 102 retransmits the contents to the server 103, if the contents are transmitted normally, the portable terminal 102 receives again the ACK for retransmission from the server 103. On the other hand, if the portable terminal 102 does not retransmit the contents transmitted to the server 103, the portable terminal 102 cannot receive the ACK for retransmission from the server 103.

In this case, the aforementioned problem cannot be solved by the conventional method for periodically retransmitting contents having the same size as contents retransmitted initially from the portable terminal to the server. However, an exemplary embodiment proposes a retransmission method considering the current network situation by confirming whether the ACK for retransmission is received from the server 103. More specifically, if the portable terminal 102 fails to receive the ACK for retransmission from the server 103, the portable terminal 102 retransmits the contents to the server 103 by determining the size of the contents with respect to a first percentage value of a Maximum Segment Size (MSS). If the ACK for retransmission is not received from the server 103 as a result of retransmitting the contents to the server 103 by determining the size of the contents with respect to the first percentage value of the MSS, the portable terminal retransmits the contents to the server 103 by determining the size of the contents with respect to a second percentage value. Herein, the first percentage value is less than 100 percents, and the second percentage value is less than the first percentage value.

If the portable terminal 102 retransmits the contents to the server 103 by determining the size of the contents with respect to the second percentage value of the MSS but fails to receive the ACK for retransmission, the portable terminal 102 retransmits the contents to the server 103 by determining the size of the contents with respect to a minimum size of a Maximum Transfer Unit (MTU). As described above, an exemplary embodiment has an advantage in that communication optimized to the current network environment can be performed by confirming whether the ACK for retransmission is received when the portable terminal 102 retransmits specific contents to the server 103.

A fourth method is for solving a case in which an error code is received from the server 103 when the portable terminal 102 transmits specific contents to the server 103. More specifically, when the portable terminal 102 transmits the specific contents to the server 103, if transmission fails, the portable terminal 102 receives an error code for indicating a transmission failure caused from the server 103. In the conventional method, if the portable terminal 102 receives the error code from the server 103, the user has to consider a solution by manually confirming the error code. However, when the error code is received from the server 103, the portable terminal 102 according to an exemplary embodiment determines the size of the contents by comparing the size of the contents with the size of the MSS of the server. More specifically, if it is determined that the size of the contents is greater than the size of the MSS, the contents are transmitted to the server 103 by determining the size of the contents to the size of the MSS.

If the error code is received again from the server 103 as a result of transmitting the contents to the server 103 by determining the size of the contents to the size of the MSS, the contents are transmitted to the server 103 by determining the size of the contents with respect to a specific percentage value of the size of the MSS, where the specific percentage value is less than the size of the MSS. If the error code is received again from the server 103 as a result of transmitting the contents to the server 103 by determining the size of the contents to the specific percentage value of the size of the MSS, the contents are transmitted to the server 103 by determining the size of the contents with respect to a minimum size of an MTU. As described above, an exemplary embodiment has an advantage in that if the portable terminal 102 receives the error code from the server 103, communication optimized to the current network environment can be performed by automatically confirming the error code.

The server 103 transmits to the portable terminal 102 the stored specific contents, or receives the specific contents transmitted from the portable terminal 102.

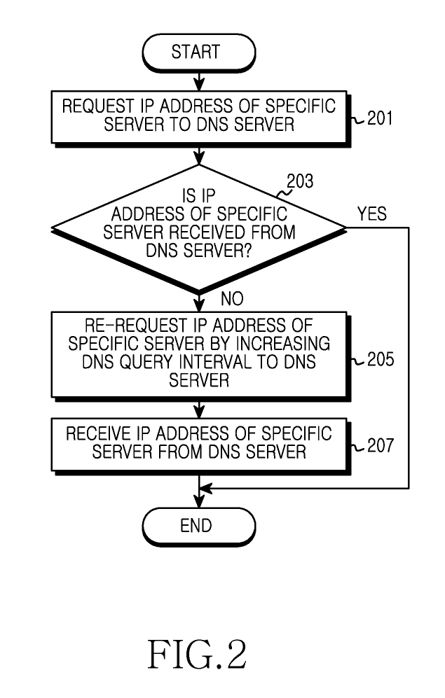

FIG. 2 is a flowchart illustrating a solution for a case in which a DNS query delay occurs according to an exemplary embodiment. First, the portable terminal 102 requests an IP address of a specific server 103 to a DNS server 101 in step 201. Herein, the DNS server 101 is also called a name server, and serves to report to the portable terminal 102 the IP address of the specific server 103 to which the portable terminal 102 intends to access. More specifically, it is necessary to use the IP address rather than a URL of the server 103 in order for the portable terminal 102 to access the specific server 103, and the DNS server 101 serves to change the URL input from the portable terminal 102 into the IP address of the server 103. For example, when a user inputs the URL of the specific server 103 to the portable terminal 102 to access the specific server 103, the DNS server 101 changes the URL of the server 103 into the IP address. As described above, a process of changing the URL into the IP address is called a name resolution.

Thereafter, the portable terminal 102 determines whether the IP address of the specific server 103 is received from the DNS server 101 in step 203. As described above, in order for the portable terminal 102 to access the specific server 103, the IP address of the server 103 must be used, and thus the portable terminal 102 determines whether the IP address of the specific server 103 is received from the DNS server 101.

If it is determined that the IP address of the specific server 103 is not received from the DNS server 101, the portable terminal 102 re-requests the IP address of the specific server 103 by increasing an interval of a DNS query in step 205. Herein, a transmission delay may occur when the portable terminal 102 receives the IP address requested to the DNS server 101. More specifically, the DNS query is occasionally delayed due to a problem of various network environments, etc. One of the main reasons for the occurrence of the DNS query problem in the conventional method is that a response for the DNS query is transmitted from the DNS server 101 to the portable terminal 102 at a time later than an actual time-out. For example, if it is assumed that a time-out of the response for the DNS query is 3 seconds in the portable terminal 102, since a response time for the DNS query is actually more than 3 seconds in the DNS server 101, the response for the DNS query is frequently delayed in the portable terminal 102.

In addition thereto, the conventional method cannot solve the problem of the delay in the DNS query because the portable terminal 102 re-requests the IP address of the specific server 103 to the DNS server 101 by using the same algorithm when the response for the DNS query is delayed. However, an exemplary embodiment proposes a solution for the aforementioned delay of the DNS query by considering a practical network environment instead of using the same algorithm as that used in the conventional method. More specifically, the portable terminal 102 re-requests the IP address of the specific server 103 to the DNS server 101 by increasing the interval of the DNS query. That is, the portable terminal 102 re-requests the IP address of the specific server 103 to the DNS server 101 by increasing a time interval of the DNS query by a determined time in proportion to the increase in a count of the DNS query. More specifically, if the portable terminal 102 confirms the delay of the DNS query, when the IP address of the specific server 103 is re-requested to the DNS server 101, the IP address is re-requested to the DNS server at 1 second, 3 seconds, and 6 seconds later respectively in first, second, and third re-request processes. Therefore, there is an advantage in that a count of DNS query delay which has frequently occurred in the conventional method can be decreased.

After re-requesting the IP address of the specific server 103 to the DNS server 101 by increasing the interval of the DNS query, the portable terminal 102 receives the IP address of the specific server 103 from the DNS server 101 in step 207. As described above, since the IP address of the specific server 103 is re-requested by increasing the interval of the DNS query, a count of the DNS query can be decreased, and thus the IP address of the specific server can be received from the DNS server 101. When the portable terminal 102 receives the IP address of the specific server 103 from the DNS server 101, the procedure of FIG. 2 ends.

If it is determined in step 203 that the portable terminal 102 receives the IP address of the specific server, the procedure of FIG. 2 also ends.

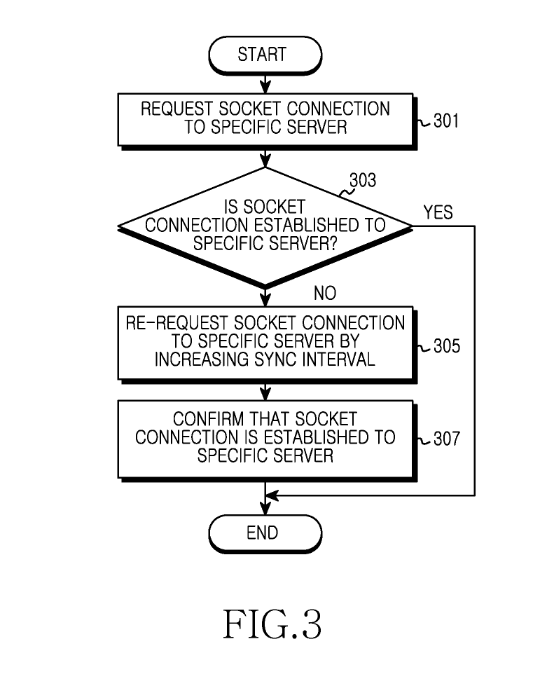

FIG. 3 is a flowchart illustrating a solution for a case in which a response delay occurs with respect to a socket connection according to an exemplary embodiment. First, the portable terminal 102 requests a socket connection to a specific server 103 in step 301. This process is for providing a solution for a case in which a response for the socket connection is not received from the server 103 when the portable terminal 102 requests the socket connection to the server 103. More specifically, a process of connecting a socket between the portable terminal 102 and the server 103 must be performed in advance in order to perform communication between the portable terminal 102 and the server 103. That is, when the portable terminal 102 requests the socket connection to the server 103, the server 103 transmits a response for the socket connection to the portable terminal 102.

Upon requesting the socket connection to the specific server 103, the portable terminal 102 determines whether the socket is connected to the specific server 103 in step 303. More specifically, since the process of connecting the socket between the portable terminal 102 and the server 103 must be performed in advance in order to perform communication between the portable terminal 102 and the server 103, the portable terminal 102 determines whether the socket is connected between the portable terminal 102 and the server 103.

If the portable terminal 102 determines that the socket is not connected between the portable terminal 102 and the specific server 103, the portable terminal 12 re-requests the socket connection to the specific server 103 by increasing a sync interval in step 305. A case in which the portable terminal 102 fails to receive the response for the socket connection from the server 103 frequently occurs in the conventional method due to a network problem or the like. For example, if it is assumed that a time-out of the response for the socket connection is 3 seconds in the portable terminal 102, the response for the socket connection is frequently delayed in the portable terminal 102 because a response time for the socket connection is more than 3 seconds in a server 103 actually in use. In this case, in the conventional method, the request of the socket connection is re-attempted at a time less than or equal to a response time of the server 103 without considering the response time of the server 103.

Therefore, the conventional method cannot solve the problem of the response delay for the socket connection. Meanwhile, an exemplary embodiment proposes a solution for the aforementioned delay of the response for the socket connection by considering a practical network environment without using the same algorithm used in the conventional method in which the socket connection is re-requested periodically. More specifically, the socket connection to the server is re-requested by increasing the interval of the sync for the socket connection from the portable terminal to the server.

That is, the socket connection from the portable terminal 102 to the server 103 is re-requested by increasing a time interval of the sync by a determined time in proportion to the increase in a count of the sync. More specifically, if the portable terminal 102 confirms the delay of the sync, when the socket connection is re-requested to the server 103, the socket connection is re-requested to the server 102 at 1 second, 3 seconds, and 6 seconds later respectively in first, second, and third re-request processes. Therefore, there is an advantage in that a count of sync delay which has frequently occurred in the conventional method can be decreased.

Thereafter, the portable terminal 102 confirms that the socket is connected in step 307. As described above, since the socket connection is re-requested by increasing the sync interval in an exemplary embodiment, the count of socket delay can be decreased, thereby being able to effectively connect the socket to the server 103. If the socket is connected between the portable terminal 102 and the server 03, the procedure of FIG. 3 ends.

If it is determined in step 303 that the socket is connected between the portable terminal 102 and the server 103, the procedure of FIG. 3 also ends.

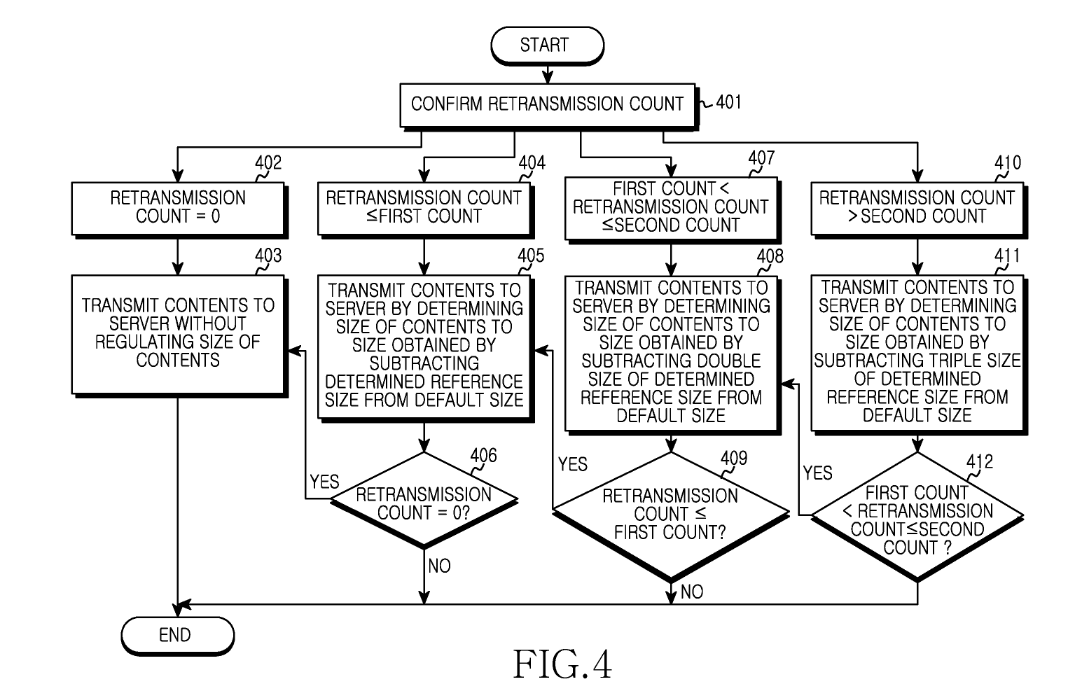

FIG. 4 is a flowchart illustrating a solution for a case in which retransmission of specific contents is requested according to an exemplary embodiment. First, the portable terminal 102 confirms a retransmission count in step 401. More specifically, when the portable terminal 102 attempts to transmit specific contents stored in the portable terminal 102 to the server 103, a retransmission request may be received from a router located between the portable terminal 102 and the server 103 due to such a reason as a packet size or a current network traffic. According to an exemplary embodiment, the portable terminal 102 automatically confirms the retransmission count.

If the portable terminal 102 determines that the retransmission count is zero as a result of confirming the retransmission count in step 402, the portable terminal 102 transmits the contents to the server 103 without regulating a size of the contents in step 403. That is, if the portable terminal 102 determines that the retransmission count is zero as the result of confirming the retransmission count, the portable terminal 102 transmits to the server 103 contents having the same size as contents initially transmitted to the server 103 instead of regulating the size of the contents, and the procedure of FIG. 4 ends. More specifically, if the portable terminal 102 confirms that the retransmission count is zero, it implies that a network environment for uploading specific contents to the server 103 is good. Therefore, it is enough for the portable terminal 102 to continuously transmit the contents having the same size as initial contents to the server 103 without having to decrease the size of the contents initially transmitted to the server 103.

If the portable terminal 102 confirms that the retransmission count is less than or equal to a predetermined first count as the result of confirming the retransmission count in step 404, the portable terminal 102 transmits to the server 103 contents having a size obtained by subtracting a determined reference size from a default size in step 405. Herein, the default size implies a value which is initially determined by a user of the portable terminal 102. Examples of a currently used default value include 1500 bytes, 1460 bytes, and 1410 bytes. In addition, the determined reference size is defined as a specific size predetermined by a vendor. That is, the reference size may vary depending on the vendor. For example, if the vendor is AT&T, 10 bytes are used as the reference size, and if the vendor is Orange, 5 bytes are used as the reference size. For example, it is assumed in the steps 404 and 405 that the default size is 1500 bytes, the determined reference size is 10 bytes, and the first count is 10. If the portable terminal confirms that the retransmission count is 7, the portable terminal 102 determines that the retransmission count (i.e., 7) is less than or equal to the first count (i.e., 10), and thus transmits to the server 103 contents having a size (i.e., 1490 bytes) obtained by subtracting the determined reference size (i.e., 10 bytes) from the default size (i.e., 1500 bytes).

Thereafter, the portable terminal 102 determines again whether the retransmission count is zero in step 406. More specifically, since the network environment is not fixed but varies on a real-time basis, the portable terminal 101 determines again whether the retransmission count is zero in order to detect a change in the network environment. If it is determined that the retransmission count is less than or equal to the determined first count as a result of transmitting to the server 103 the contents having the size obtained by subtracting the determined reference size from the default size, since a current size of the contents is suitable for the network environment, the remaining contents are entirely transmitted, and then the procedure of FIG. 4 ends.

Otherwise, if it is determined that the retransmission count is zero as the result of transmitting to the server 103 the contents having the size obtained by subtracting the determined reference size from the default size, the portable terminal 102 transmits to the server 103 contents having the same size as contents initially transmitted to the server 103 in step 403. That is, if the retransmission count is zero, it implies that the network environment is improved. Therefore, instead of transmitting to the server 103 the contents having the size obtained by subtracting the determined reference size from the default size, the portable terminal 102 transmits to the server 103 the contents having the same size as the contents initially transmitted to the server. As such, the exemplary embodiment attempts retransmission to the server 103 by regulating the size of the contents according to the varying network environment instead of continuously attempting to retransmit contents having a fixed size to the server 103.

If the portable terminal determines that the retransmission count is greater than the predetermined first count and less than or equal to the predetermined second count as the result of confirming the retransmission count in step 407, the portable terminal 102 transmits to the server 103 contents having a size obtained by subtracting a double size of the determined reference size from the default size in step 408. For example, assume that the default size is 1500 bytes, the determined reference size is 10 bytes, the first count is 10, and the second count is 20. If it is determined that the retransmission count confirmed by the portable terminal 102 is 15, the portable terminal 102 determines that the retransmission count (i.e., 15) is less than or equal to the first count (i.e., 10), and thus transmits to the server contents having a size (i.e., 1480 bytes) obtained by subtracting a double size (i.e., 20 bytes) of the determined reference size from the default size (i.e., 1500 bytes).

Thereafter, the portable terminal 102 determines again whether the retransmission count is less than or equal to the predetermined first count in step 409. More specifically, since the network environment is not fixed but varies on a real-time basis, the portable terminal 102 determines again the retransmission count in order to detect a change in the network environment. If it is determined that the retransmission count is less than or equal to the predetermined first count as the result of transmitting the contents having the size obtained by subtracting the double size of the determined reference size from the default size to the server, the portable terminal 102 transmits to the server 103 the contents having the size obtained by subtracting the determined reference size from the default size, and then the procedure of FIG. 4 ends.

Otherwise, if it is determined that the retransmission count is greater than the predetermined first count and less than or equal to the predetermined second count as the result of transmitting to the server 103 the contents having the size obtained by subtracting the double size of the determined reference size from the default size, the portable terminal 102 transmits to the server 103 the contents having the size obtained by subtracting the determined reference size from the default size in step 405. That is, if the retransmission count is decreased, it implies that the network environment is improved. Therefore, instead of transmitting the contents having the size obtained by subtracting the double size of the determined reference size from the default size, the portable terminal 102 transmits to the server 103 the contents having the size obtained by subtracting the determined reference size from the default size. As such, an exemplary embodiment attempts retransmission to the server 103 by regulating the size of the contents according to the varying network environment instead of continuously attempting to retransmit contents having a fixed size to the server 103.

If the portable terminal 102 determines that the retransmission count is greater than the predetermined second count as the result of confirming the retransmission count in step 410, the portable terminal 102 transmits to the server 103 contents having a size obtained by subtracting a triple size of the determined reference size from the default size in step 411. For example, assume that the default size is 1500 bytes, the determined reference size is 10 bytes, and the second count is 20. If it is determined that the retransmission count confirmed by the portable terminal is 23, the portable terminal determines that the retransmission count (i.e., 23) is greater than the second count (i.e., 20), and thus transmits to the server contents having a size (i.e., 1470 bytes) obtained by subtracting a triple size (i.e., 30 bytes) of the determined reference size from the default size (i.e., 1500 bytes).

Thereafter, the portable terminal 102 determines again whether the retransmission count is greater than the predetermined first count and less than or equal to the predetermined second count in step 412. More specifically, since the network environment is not fixed but varies on a real-time basis, the portable terminal 102 determines again the retransmission count in order to detect a change in the network environment. If it is determined that the retransmission count is greater than the predetermined first count and less than or equal to the predetermined second count as the result of transmitting to the server 103 the contents having the size obtained by subtracting the triple size of the determined reference size from the default size, the portable terminal 102 transmits to the server 103 the contents having the size obtained by subtracting the double size of the determined reference size from the default size, and then the procedure of FIG. 4 ends.

Otherwise, if it is determined that the retransmission count is greater than the predetermined first count and less than or equal to the predetermined second count as the result of transmitting to the server 103 the contents having the size obtained by subtracting the triple size of the determined reference size from the default size, the portable terminal 102 transmits to the server the contents having the size obtained by subtracting the double size of the determined reference size from the default size in step 408. That is, if the retransmission count is decreased, it implies that the network environment is improved. Therefore, instead of transmitting the contents having the size obtained by subtracting the triple size of the determined reference size from the default size, the portable terminal 102 transmits to the server 103 the contents having the size obtained by subtracting the double size of the determined reference size from the default size. As such, an exemplary embodiment attempts retransmission to the server 103 by regulating the size of the contents according to the varying network environment instead of continuously attempting to retransmit contents having a fixed size to the server 103. In addition thereto, a history of the transmissions can be stored, and thus the stored history can be utilized.

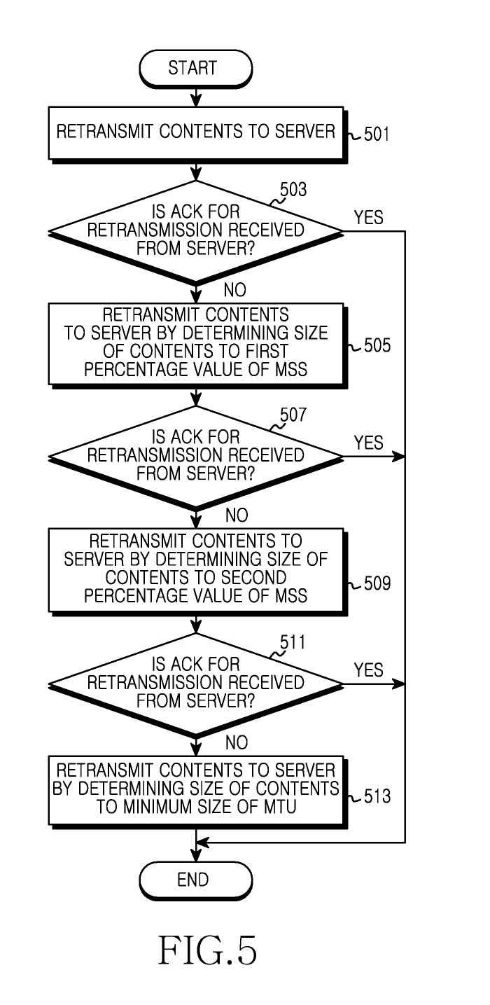

FIG. 5 is a flowchart illustrating an exemplary solution for a case in which ACK for retransmission is not received from a server 103 according to an exemplary embodiment. First, the portable terminal 102 retransmits contents to the server 103 in step 501. That is, when specific contents stored in the portable terminal 102 are transmitted to the server 103, retransmission can be requested from a router located between the portable terminal 102 and the server 103 due to such a reason as a packet size, current network traffic, etc. In this case, the portable terminal 102 retransmits the specific contents to the server 103.

Upon retransmitting the specific contents to the server 103, the portable terminal 102 determines whether the ACK for retransmission is received from the server 103 in step 503. More specifically, when the portable terminal 102 retransmits the contents to the server 103, if the retransmitted contents are transmitted normally, the portable terminal 102 receives the ACK for retransmission from the server 103. Otherwise, if the portable terminal 102 does not retransmit the contents to the server 103, the portable terminal 102 cannot receive the ACK for retransmission from the server 103.

If it is determined that the portable terminal 102 fails to receive the ACK for retransmission from the server 103, the portable terminal 102 retransmits the contents to the server 103 by determining a size of the contents with respect to a first percentage value of a Maximum Segment Size (MSS) in step 505. The aforementioned problem cannot be solved when using the conventional method in which contents having the same size as contents initially retransmitted to the server 103 are periodically retransmitted by the portable terminal 102. However, an exemplary embodiment provides a method in which the portable terminal 102 retransmits the contents in consideration of a current network situation by confirming whether the ACK for retransmission is received from the server 103. More particularly, if the portable terminal 102 fails to receive the ACK for retransmission from the server 103, the portable terminal 102 retransmits the contents to the server 103 by determining the size of the contents with respect to the first percentage value of the MSS. Herein, the MSS is an acronym of Maximum Segment Size, and is defined as a maximum size of user data that can be transmitted on a Transmission Control Protocol (TCP). In addition, the first percentage value is a percentage value determined by a user, and is defined as a percentage value less than 100 percent. For a further detailed explanation of step 503, it is assumed that the size of the MSS is 1000 bytes and the first percentage value is determined to be 70 percent. If it is determined that the portable terminal 102 fails to receive the ACK for retransmission from the server 103, the portable terminal 102 determines the size of the contents to a size (i.e., 700 bytes) of the first percentage value (i.e., 70 percent), and retransmits the contents having the determined size (i.e., 700 bytes) to the server 103.

Thereafter, the portable terminal 102 determines whether the ACK for retransmission is received from the server 103 in step 507. More specifically, after retransmitting the contents to the server 103 by determining the size of the contents to the first percentage value of the MSS, the portable terminal 102 determines whether the ACK for retransmission is received from the server 103 in order to determine whether there is a change in the network environment. That is, this is to detect and cope with the change in the network environment in practice after transmission even if the contents are retransmitted to the server 103 by determining the size of the contents to the first percentage value of the MSS.

If it is determined that the portable terminal 102 retransmits the contents to the server 103 by determining the size of the contents with respect to the first percentage value of the MSS but fails to receive the ACK for retransmission from the server 103, the portable terminal 102 retransmits the contents to the server by determining the size of the contents with respect to a second percentage value in step 509. Herein, the second percentage value is defined as a value smaller than the first percentage value. More specifically, assume that the size of the MSS is 100 bytes and the second percentage value is determined to be 50 percent. If it is determined that the portable terminal 102 fails to receive the ACK for retransmission from the server 103, the portable terminal 102 determines the size of the contents to be a size (i.e., 500 bytes) of the second percentage value (i.e., 50 percents) of the MSS (i.e., 1000 bytes) and retransmits the contents having the determined size (i.e., 500 bytes) to the server.

Thereafter, the portable terminal 102 determines whether the ACK for retransmission is received from the server 103 in step 511. More specifically, after retransmitting the contents to the server 103 by determining the size of the contents with respect to the second percentage value of the MSS, the portable terminal 102 determines again whether the ACK for retransmission is received from the server 103 in order to determine whether there is a change in the network environment. That is, this is to detect and cope with the change in the network environment in practice after transmission even if the contents are retransmitted to the server 103 by determining the size of the contents with respect to the second percentage value of the MSS.

If it is determined that the portable terminal 102 retransmits the contents to the server 103 by determining the size of the contents with respect to the second percentage value of the MSS but fails to receive the ACK for retransmission from the server 103, the portable terminal 102 retransmits the contents to the server by determining the size of the contents with respect to a minimum size of a Maximum Transfer Unit (MTU) size in step 513. Herein, the MTU is a maximum data amount that can be transmitted through a network, and is a relative concept which varies depending on a media type of the network. More specifically, if the portable terminal 102 fails to receive the ACK for retransmission from the server 103 as a result of retransmitting specific contents as described above, the portable terminal 102 retransmits again the contents by respectively determining data sizes with respect to the first percentage value and the second percentage value of the MSS. This means that, if it is determined that the portable terminal 102 fails again to receive the ACK for the retransmitted contents, as a last process, the contents are retransmitted to the server 103 by determining the size of the contents with respect to a maximum size (i.e., 576 bytes) of the MTU size.

If it is determined in the aforementioned processes (i.e., steps 503, 507, and 511) that the portable terminal 102 receives the ACK for retransmission from the server 103, the procedure of FIG. 5 ends.

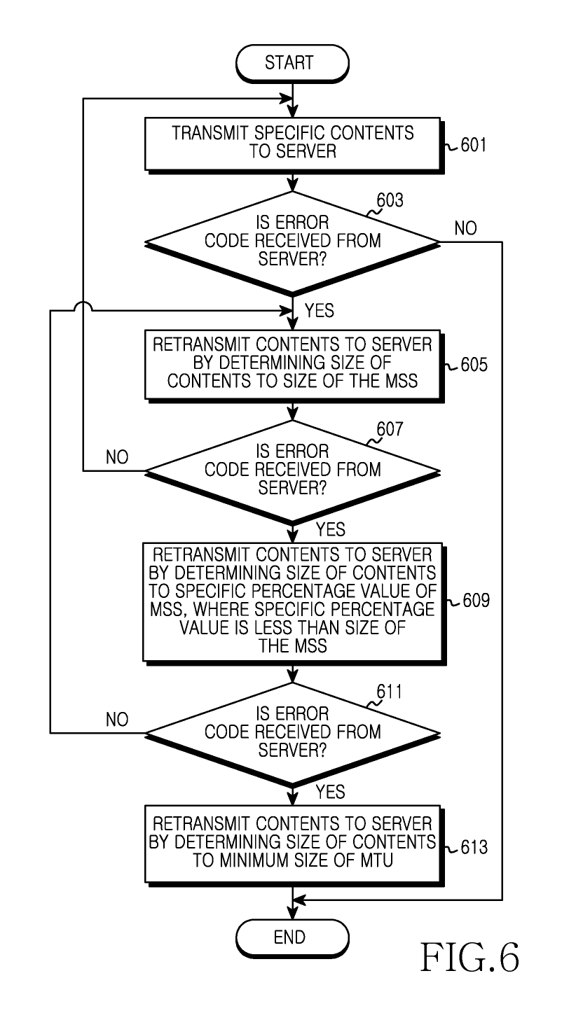

FIG. 6 is a flowchart illustrating an exemplary solution for a case in which an error code is received from a server 103 according to an exemplary embodiment. First, the portable terminal 102 transmits specific contents to the server 103 in step 601, and thereafter determines whether the error code is received from the server in step 603. More specifically, when the portable terminal 102 transmits the specific contents to the server 103, if transmission fails, the portable terminal 102 receives the error code capable of identifying a transmission failure cause from the server 103. Conventionally, when the portable terminal 102 receives the error code from the server 103, a user has to manually solve the problem by confirming the error code. However, the portable terminal according to an exemplary embodiment determines a size of the contents by comparing the size of the contents with a size of an MSS of the server 103 when the error code is received from the server 103.

If it is determined that the portable terminal 102 receives the error code from the server 103, the portable terminal 102 determines the size of the contents by comparing the size of the contents with the size of the MSS, and retransmits the contents having the determined size to the server 103 in step 605. More specifically, if it is determined that the size of the contents is greater than the size of the MSS, the portable terminal 102 determines the size of the contents by comparing the size of the contents with a the size of the MSS and then retransmits the contents to the server 103. Herein, regarding the MSS, an MSS delivered by the server 103 is used when socket connection is established to the server 103.

Thereafter, the portable terminal 102 determines again whether the error code is received from the server 103 in step 607. More specifically, the portable terminal 102 determines the size of the contents with respect to the size of the MSS and then retransmits the contents to the server 103, and thereafter determines again whether the error code for retransmission is received in order to determine whether there is a change in a network environment. That is, this is to detect and cope with the change in the network environment in practice after transmission even if the contents are retransmitted to the server 103 by determining the size of the contents with respect to the size of the MSS.

If it is determined in step 607 that the portable terminal 102 receives the error code from the server 103, the portable terminal 102 determines the size of the contents with respect to a specific percentage value of the MSS, where the specific percentage value is less than the size of the MSS, and retransmits the contents to the server 103 in step 609. Herein, the specific percentage value is defined as a value less than 100 percent. That is, if the portable terminal 102 receives again the error code from the server 103 as a result of retransmitting the contents by determining the size of the contents with respect to the size of the MSS, the portable terminal 102 determines the size of the contents with respect to the specific percentage value of the MSS, where the specific percentage value is less than the MSS size, and then retransmits the contents to the server 103.

Thereafter, the portable terminal 102 determines again whether the error code is received from the server 103 in step 611. More specifically, the portable terminal 102 determines the size of the contents with respect to the specific percentage value of the MSS, wherein the specific percentage value is less than the MSS size, and retransmits the contents to the server 103, and thereafter determines whether the error code for retransmission is received from the server in order to determine whether there is a change in the network environment. That is, this is to detect and cope with the change in the network environment in practice after transmission even if the contents are retransmitted to the server 103 by determining the size of the contents to the specific percentage value of the MSS, where the specific percentage value is less than the size of the MSS.

If it is determined in step 611 that the portable terminal 102 receives the error code from the server 103, the portable terminal 102 determines the size of the contents with respect to a minimum size of the MTU size and retransmits the contents having the determined size to the server 103 in step 613. Herein, the MTU is a maximum data amount that can be transmitted through a network, and is a relative concept which varies depending on a media type of the network. That is, when the error code is received again from the server 103 even if the portable terminal 102 determines the size of the contents to the size of the MSS and the specific percentage value of the MSS, where the specific percentage value is less than the size of the MSS, and retransmits the contents having the determined size to the server 103, the portable terminal 102 determines the size of the contents with respect to the minimum size of the MTU size, and retransmits the contents having the determined size to the server 103. Thereafter, the procedure of FIG. 6 ends.

Otherwise, if it is determined in step 603 that the portable terminal 102 does not receive the error code, the procedure of FIG. 6 also ends.

If it is determined in step 607 that the portable terminal 102 does not receive the error code from the server 103, the portable terminal 102 determines the size of the contents to a default size of the contents and retransmits the contents having the determined size to the server 103 in step 601. That is, if it is determined that the portable terminal 102 does not receive the error code as the result of retransmitting the contents to the server 103 by determining the size of the contents to be the size of the MSS, it implies that the network environment is improved. Therefore, the portable terminal 102 determines the size of the contents to the default size and retransmits the contents to the server 103.

If it is determined in step 611 that the portable terminal 102 does not receive the error code from the server 102, the portable terminal 102 determines the size of the contents to the size of the MSS and then retransmits the contents having the determined size to the server 103 in step 605. That is, if it is determined that the portable terminal 102 does not receive the error code as the result of retransmitting the contents having the determined size to the server 103 by determining the size of the contents with respect to the minimum size of the MTU size, this determination implies that the network environment is improved. Therefore, the portable terminal 102 determines the size of the contents with respect to the size of the MSS and retransmits the contents having the determined size to the server 103.

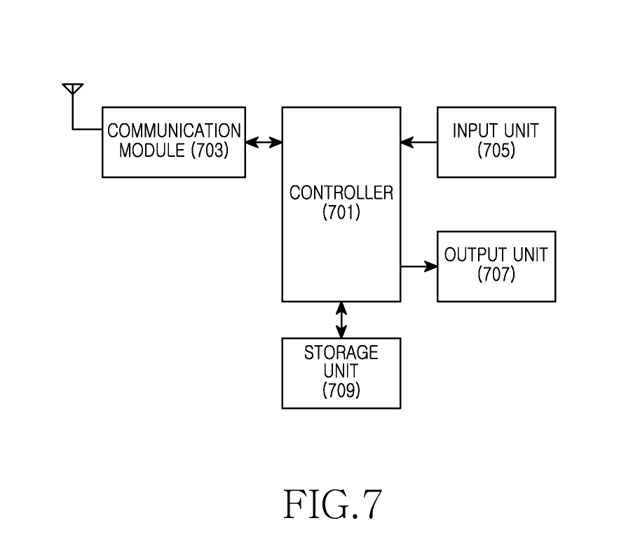

FIG. 7 is a block diagram illustrating a structure of a portable terminal according to an exemplary embodiment. Referring to FIG. 7, the portable terminal according to an exemplary embodiment includes a controller 701, a communication module 703, an input unit 705, an output unit 707, and a storage unit 709.

The controller 701 provides overall control of the portable terminal 102. For example, the controller 701 confirms a delay in reception of a specific server's IP address requested to a DNS server 101, and confirms a delay in a socket connection requested to the specific server 103. Further, the controller 701 increases a time interval of a DNS query by a determined time in proportion to the increase in a count of the DNS query, and increases a time interval of a sync by a determined time in proportion to the increase in a count of the sync. Furthermore, the controller 701 confirms that the socket connection is established to the specific server, confirms a retransmission count of specific contents retransmitted to the server 103, and determines whether ACK is received from the server 103. In addition, the controller 701 determines a size of the contents by comparing the size of the contents with a size of an MSS of the server 103.

The communication module 703 processes a signal transmitted and received through an antenna for voice and data communication. For example, the communication module 703 re-requests the IP address to the DNS server 101 by increasing the interval of the DNS query, and re-requests the socket connection to the specific server 103 by increasing the sync interval. Further, the communication module 703 requests the IP address of the specific server 103 to the DNS server 101, and requests the socket connection to the specific server 103.

Furthermore, the communication module 703 re-requests an IP address to the DNS server 101 and receives the IP address of the specific server 103 from the DNS server 101. In addition, the communication module 703 regulates the size of the contents according to the retransmission count, and transmits to the server 103 contents having the same size as the contents of which the size is regulated. In addition, the communication module 703 uploads specific contents to the server 103, and if it is determined that the retransmission count is zero, transmits to the server 103 contents of which a size is not regulated.

In addition, if it is determined that the retransmission count is less than or equal to a determined first count, the communication module 703 transmits the contents to the server 103 by regulating the size of the contents to a size obtained by subtracting a determined reference size from a default size. In addition, if it is determined that the retransmission count is greater than or equal to the determined first count and less than or equal to a determined second count, the communication module 703 transmits the contents to the server 103 by regulating the size of the contents to a size obtained by subtracting a double size of the determined reference size from the default size.

In addition, if it is determined that the retransmission count is greater than the determined second count, the communication module 703 transmits the contents to the server 103 by regulating the size of the contents to a size obtained by subtracting a triple size of the determined reference size from the default size. In addition, if it is determined that ACK is not received from the server 103, the communication module 703 transmits the contents to the server 103 by determining the size of the contents with respect to a first percentage value of an MSS. In addition, if it is determined that ACK for retransmission is not received as a result of retransmitting to the server 103 the contents having the size determined to the first percentage value of the MSS, the communication module 703 transmits the contents to the server 103 by determining the size of the contents to a second percentage value of the MSS, where the second percentage value is less than the first percentage value of the MSS.

In addition, if it is determined that the ACK for retransmission is not received as a result of retransmitting to the server 103 the contents of which the size is determined to the second percentage value of the MSS, the communication module 703 transmits the contents to the server 103 by determining the size of the contents to a minimum size of an MTU. Further, the communication module 703 uploads specific contents to the server 103, and receives an error code from the server 103. Furthermore, if it is determined that the size of the contents is greater than the size of the MSS, the communication module 703 transmits the contents to the server 103 by determining the size of the contents to the size of the MSS, and if the error code is received again from the server 103 as a result of retransmitting the contents to the server 103 by determining the size of the contents to the size of the MSS, the communication module 703 transmits the contents the server 103 by determining the size of the contents to a specific percentage value of the MSS, where the specific percentage value is less than the size of the MSS.

In addition, if the error code is received again from the server 103 as a result of retransmitting the contents to the server 103 by determining the size of the contents with respect to the specific percentage value of the size of the MSS, the communication module 703 transmits the contents to the server 103 by determining the size of the contents to the minimum size of the MTU. In addition, if it is determined that the error code is not received from the server as a result of retransmitting the contents having the respective determined sizes to the server 103, the communication module 703 transmits the contents to the server 103 by determining the size of the contents with respect to the specific percentage value of the size of the MSS when the size of the contents is determined with respect to the minimum size of the MTU, and transmits the contents to the server 103 by determining the size of the contents with respect to a size of contents initially transmitted to the server 103 when the size of the contents is determined to be the size of the MSS.

The input unit 705 provides the controller 701 with input data generated by a user's selection.

The output unit 707 displays status information of the portable terminal 102, a menu screen, and story information under the control of the controller 701.

The storage unit 709 may include a program storage unit for storing a program for controlling the operation of the terminal and a data storage unit for storing data generated while the program is executed. For example, the storage unit 709 stores the respective regulated sizes of the contents.

In the aforementioned structure, the controller 701 can perform overall functions of the portable terminal 102. However, these functions are separately configured and illustrated in the exemplary embodiments to describe the respective functions separately. Therefore, when the product is implemented in practice, all functions of the portable terminal 102 may be processed by the controller 701 or only some of the functions of the portable terminals 102 may be processed by the controller 701.

While the present invention has been particularly shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A method of operating a portable terminal, the method comprising:
confirming a delay in reception of an Internet Protocol (IP) address of a specific server requested to a Domain Name System (DNS) server;
re-requesting the IP address of the specific server to the DNS server by increasing an interval of a DNS query;
confirming a delay in a socket connection requested to the specific server; and
re-requesting the socket connection to the specific server by increasing an interval of a sync.

2. The method of claim 1, further comprising requesting the IP address of the specific server to the DNS server and requesting the socket connection to the specific server.

3. The method of claim 1, wherein the re-requesting of the IP address of the specific server to the DNS server by increasing the interval of the DNS query comprises increasing a time interval of the DNS query by a determined time in proportion to an increase in a count of the DNS query.

4. The method of claim 1, wherein the re-requesting of the socket connection to the specific server by increasing the interval of the sync comprises increasing a time interval of the sync by a determined time in proportion to an increase in a count of the sync.

5. A method of operating a portable terminal, the method comprising:
confirming a retransmission count for retransmitting contents to a server;
regulating a size of the contents according to the retransmission count and transmitting to the server the contents having the size regulated; and
determining whether ACKnowledge (ACK) for the transmission is received from the server.

6. The method of claim 5, wherein the regulating of the size of the contents according to the retransmission count and transmitting to the server the contents having the size regulated comprises, if it is determined that the retransmission count is zero, transmitting to the server the contents of which a size is not regulated, or
wherein the regulating of the size of the contents according to the retransmission count and transmitting to the server the contents having the size regulated comprises, if it is determined that the retransmission count is less than or equal to a determined first count, transmitting to the server the contents having the size regulated by subtracting a determined reference size from a default size.

7. The method of claim 5, wherein the regulating of the size of the contents according to the retransmission count and transmitting to the server the contents having the size regulated comprises, if it is determined that the retransmission count is greater than or equal to a determined first count and less than or equal to a determined second count, transmitting to the server the contents having the size regulated by subtracting a double size of a determined reference size from a default size, or
wherein the regulating of the size of the contents according to the retransmission count and transmitting to the server the contents having the size regulated comprises, if it is determined that the retransmission count is greater than a determined second count, transmitting to the server the contents having the size regulated by subtracting a triple size of a determined reference size from a default size.

8. The method of claim 5, wherein the determining whether the ACK for the transmission is received from the server comprises, if it is determined that the ACK is not received from the server, transmitting the contents to the server by determining the size of the contents with respect to a first percentage value of a Maximum Segment Size (MSS), if it is determined that the ACK for the transmission is not received as a result of transmitting to the server the contents of which the size is determined according to the first percentage value of the MSS, transmitting the contents to the server by determining the size of the contents with respect to a second percentage value of the MSS, where the second percentage value is less than the first percentage value of the MSS, and if it is determined that the ACK for the transmission is not received as a result of transmitting to the server the contents of which the size is determined according to the second percentage value of the MSS, transmitting the contents to the server by determining the size of the contents with respect to a minimum size of a Maximum Transfer Unit (MTU).

9. A method of operating a portable terminal, the method comprising:
uploading specific contents to a server;
receiving an error code from the server; and
determining a size of the contents by comparing the size of the contents with a size of a Maximum Segment Size (MSS) of the server,
wherein the determining of the size of the contents by comparing the size of the contents with the size of the MSS of the server comprises, if it is determined that the size of the contents is greater than the size of the MSS, transmitting the contents to the server by determining the size of the contents with respect to the size of the MSS.

10. The method of claim 9, further comprising, if an error code is received from the server as a result of transmitting the contents to the server by determining the size of the contents with respect to the size of the MSS, transmitting the contents to the server by determining the size of the contents with respect to a specific percentage value of the size of the MSS, where the specific percentage value is less than the size of the MSS,
if the error code is received from the server as a result of transmitting the contents to the server by determining the size of the contents with respect to the specific percentage value of the size of the MSS, transmitting the contents to the server by determining the size of the contents with respect to a minimum size of a Maximum Transfer Unit (MTU), and if it is determined that the error code is not received from the server as a result of retransmitting the contents having the determined size to the server, transmitting the contents to the server by determining the size of the contents with respect to a specific percentage value of the size of the MSS if the size of the contents is determined with respect to a minimum size of the MTU, and transmitting the contents to the server by determining the size of the contents with respect to a size of contents initially transmitted to the server if the size of the contents is determined to be the size of the MSS.

11. A portable terminal apparatus comprising:
a controller for confirming a delay in reception of an Internet Protocol (IP) address of a specific server requested to a Domain Name System (DNS) server and for confirming a delay in a socket connection requested to the specific server; and
a communication module for re-requesting the IP address of the specific server to the DNS server by increasing an interval of a DNS query and for re-requesting the socket connection to the specific server by increasing an interval of a sync.

12. The apparatus of claim 11, wherein the communication module requests the IP address of the specific server to the DNS server and requests the socket connection to the specific server.

13. The apparatus of claim 11, wherein the controller increases a time interval of the DNS query by a determined time in proportion to an increase in a count of the DNS query.

14. The apparatus of claim 11, wherein the controller increases a time interval of the sync by a determined time in proportion to the increase in a count of the sync.

15. A portable terminal apparatus comprising:
a controller for confirming a retransmission count for retransmitting contents to a server and for determining whether an ACKnowledge (ACK) is received from the server; and
a communication module for regulating a size of the contents according to the retransmission count and transmitting to the server the contents having the regulated size.

16. The apparatus of claim 15, wherein if it is determined that the retransmission count is zero, the communication modules transmits to the server the contents of which a size is not regulated, or
wherein if it is determined that the retransmission count is less than or equal to a determined first count, the communication module transmits to the server the contents of which the size is regulated by subtracting a determined reference size from a default size, or

17. The apparatus of claim 15, wherein if it is determined that the retransmission count is greater than or equal to a determined first count and less than or equal to a determined second count, the communication module transmits to the server the contents of which the size is regulated by subtracting a double size of a determined reference size from a default size or if it is determined that the retransmission count is greater than a determined second count, the communication module transmits to the server the contents of which the size is regulated by subtracting a triple size of a determined reference size from a default size,

18. The apparatus of claim 15, wherein if it is determined that the ACK is not received from the server, the communication module transmits the contents to the server by determining the size of the contents with respect to a first percentage value of a Maximum Segment Size (MSS), wherein if it is determined that the ACK for the transmission is not received as a result of transmitting to the server the contents of which the size is determined with respect to the first percentage value of the MSS, the communication module transmits the contents to the server by determining the size of the contents with respect to a second percentage value of the MSS, where the second percentage value is less than the first percentage value of the MSS, and wherein if it is determined that the ACK for the transmission is not received as a result of transmitting to the server the contents of which the size is determined with respect to the second percentage value of the MSS, the communication module transmits the contents to the server by determining the size of the contents with respect to a minimum size of a Maximum Transfer Unit (MTU).

19. A portable terminal apparatus comprising:
a communication module for uploading specific contents to a server and for receiving an error code from the server; and
a controller for determining a size of the contents by comparing a size of the contents with a size of Maximum Segment Size (MSS) of the server,
wherein if it is determined that the size of the contents is greater than the size of the MSS, the communication module transmits the contents to the server by determining the size of the contents with respect to the size of the MSS.

20. The apparatus of claim 41, wherein if an error code is received from the server as a result of retransmitting the contents to the server by determining the size of the contents with respect to the size of the MSS, the communication module transmits the contents to the server by determining the size of the contents with respect to a specific percentage value of the size of the MSS, where the specific percentage value is less than the size of the MSS, if the error code is received from the server as a result of retransmitting the contents to the server by determining the size of the contents with respect to the specific percentage value of the size of the MSS, the communication module transmits the contents to the server by determining the size of the contents with respect to a minimum size of a Maximum Transfer Unit (MTU), if it is determined that the error code is not received from the server as a result of retransmitting the contents having the respective determined size to the server, the communication module transmits the contents to the server by determining the size of the contents to a specific percentage value of the size of the MSS if the size of the contents is determined with respect to a minimum size of the MTU, and transmits the contents to the server by determining the size of the contents to a size of contents initially transmitted to the server if the size of the contents is determined with respect to the size of the MSS.
